(19) United States
(12) Patent Application Publication
(10) Pub. No.: US 2008/0248440 A1
(43) Pub. Date: Oct. 9, 2008

(54) Orthodontic Bracket

(76) Inventor: Arthur L. Wool, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/139,536

(22) Filed: Jun. 16, 2008

Related U.S. Application Data
(63) Continuation-in-part of application No. 11/481,969, filed on Jul. 7, 2006.
(60) Provisional application No. 60/697,549, filed on Jul. 11, 2005.
(60) Provisional application No. 60/968,959, filed on Aug. 30, 2007.

(51) Int. Cl. A61C 7/14

(52) U.S. Cl. 433/10

(57) ABSTRACT

An orthodontic bracket includes a base, an archwire slot extending through the base, and archwire slot extensions extending substantially in the mesiodistal direction from opposite sides of the base.

### CROSS-REFERENCE TO RELATED APPLICATIONS

This application is a continuation-in-part of application of U.S. application Ser. No. 11/481,969, filed Jul. 7, 2006, the contents of which are incorporated herein by reference, which claims benefit of the filing date of prior provisional application Ser. No. 60/697,549, filed Jul. 11, 2005, the contents of which are incorporated herein by reference. This application also claims benefit of the filing date of prior provisional application Ser. No. 60/968,959, filed Aug. 30, 2007, the contents of which are incorporated herein by reference.

### BACKGROUND OF THE INVENTION

Orthodontic brackets having a base and a slot for receiving an archwire are well known in the orthodontic field. Typically, the brackets are attached to respective teeth or to base plates bonded to the teeth. The brackets are attached to the teeth so that they have an orientation with respect to each tooth and with respect to each other determined by the orthodontist in a manner designed to correct the malposition of a tooth or teeth by the treatment.

In order to correct the malposition of a tooth or teeth, an archwire is inserted into the archwire slots of the brackets. The archwire exerts a torque on selected brackets, determined in part by the positioning of the brackets on the teeth, to gradually move the teeth into proper position.

### BRIEF SUMMARY OF THE INVENTION

An orthodontic bracket includes a base, an archwire slot extending through the base, and archwire slot extensions extending substantially in the mesiodistal direction from opposite sides of the base.

### BRIEF DESCRIPTION OF THE SEVERAL VIEWS OF DRAWINGS

The present invention can be better understood with reference to the accompanying figures in which:

FIG. 1 is a perspective view of a first embodiment of the self-locking orthodontic bracket of the present invention;

FIG. 2 is a side view of one part of the first embodiment of the self-locking orthodontic bracket of the present invention;

FIG. 3 is a perspective view of a second embodiment of the self-locking orthodontic bracket of the present invention;

FIG. 4 is a perspective view of a third embodiment of the self-locking orthodontic bracket of the present invention;

FIG. 5 is a perspective view of a fourth embodiment of the self-locking orthodontic bracket of the present invention.

### DETAILED DESCRIPTION OF THE INVENTION

The present invention can be better understood with reference to the accompanying figures showing various embodiments of the self-locking orthodontic bracket of the present invention. While the accompanying figures show and this description describes some embodiments of the invention, the invention is not limited thereto. One skilled in the art will understand that numerous variations and modifications are possible without departing from the spirit and scope of the invention defined by the following claim(s).

The present specification uses the terms “occlusal-gingival” and “mesiodistal” to refer to directions known in the orthodontic art. These terms, whether or not modified by the word “substantially,” are intended to include variations from these directions in which the brackets may be aligned by an orthodontist in an orthodontic treatment.

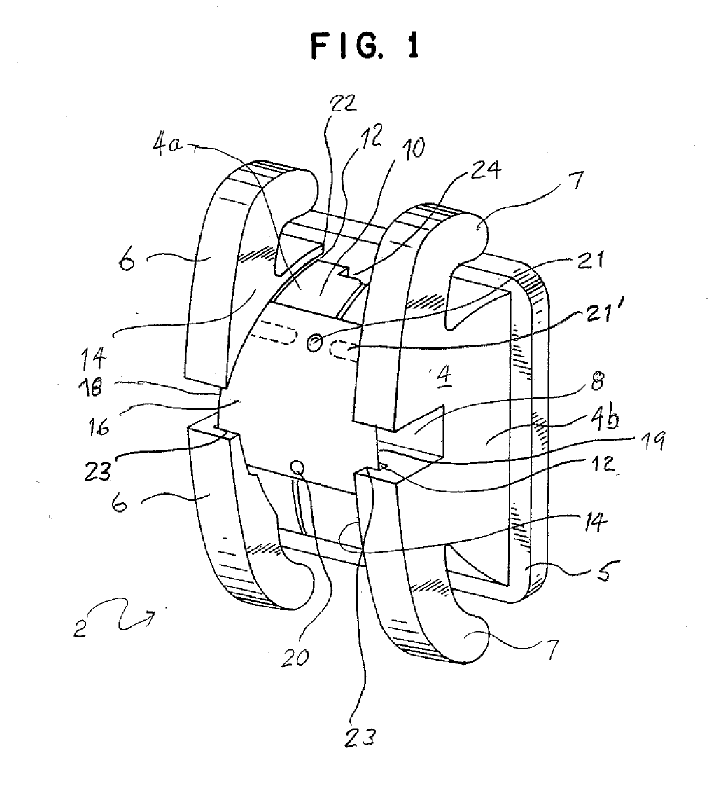

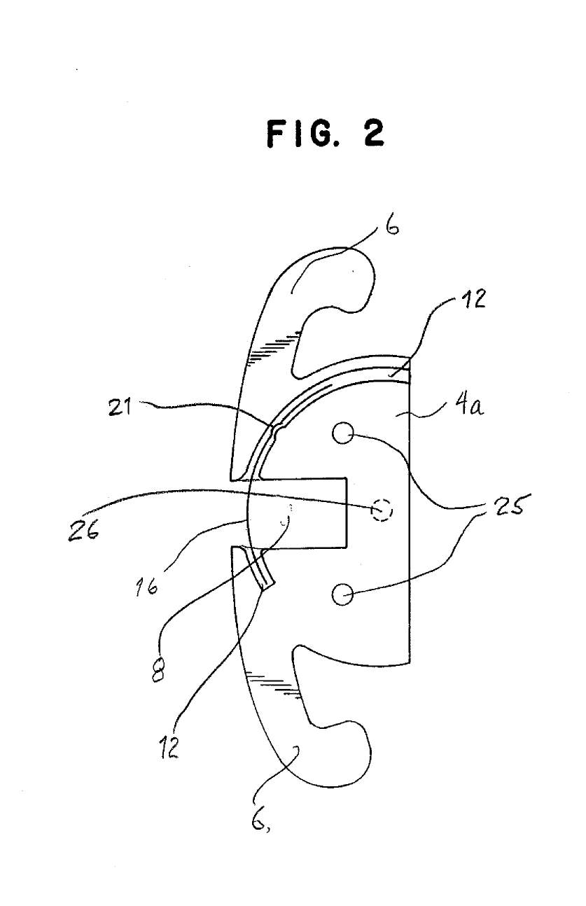

FIGS. 1 and 2 show one example of the orthodontic bracket of the present invention. As shown in FIG. 1, the bracket 2 includes a base 4, which may in a preferred embodiment be made of two parts 4a, 4b for ease of manufacture. The base 4 is bonded in this embodiment to a pad 5 that is in turn bonded to a patient's tooth. Alternatively, the base 4 may be bonded directly to the patient's tooth. A pair of substantially parallel, spaced tie wings 6, 7 extend from the base 4 substantially in the occlusal-gingival direction, and an archwire slot 8 extends through the base 4 and the tie wings 6, 7. The archwire slot 8 extends through the base 4 and the tie wings 6, 7 substantially in the mesiodistal direction.

The base 4 has a curved anterior surface 10 through which the archwire slot 8 extends. A groove 12 is provided in an inside surface 14 of each tie wing 6, 7. The groove 12 in each tie wing 6, 7 is located adjacent to and substantially follows at least a part of the curved anterior surface 10 of the base 4. A slidable locking cover 16 has opposed side edges 18, 19 and is adapted to be disposed in the respective grooves 12 in the inside surface of each tie wing 6, 7. The cover 16 is slidable along the curved anterior surface 10 of the base 4 between an open position (not shown) clear of the archwire slot 8 and a closed position (shown in the figure) covering the archwire slot 8 to enable the cover 16, in the closed position, to lock an archwire in the archwire slot.

The cover 16 is preferably made of metal and, in one embodiment, can be made of a superelastic alloy, e.g., superelastic NiTi. In order to increase friction between the cover 16 and the anterior surface 10 of the base 4, thereby keeping the cover in the open or closed position until moved by the orthodontist, the cover 16, before it is inserted in the grooves 12, can have a different radius of curvature than the anterior surface 10 and the grooves 12. For example, the cover 16, before it is inserted in the grooves 12, can be flat but made of a flexible material.

If the cover 16 is not made of a flexible material, it should have substantially the same radius of curvature as the anterior surface 10.

In order to assist the orthodontist in moving the cover 16 between the open and closed positions, the cover 16 may include concave portions 20, 21 or convex portions 20, 21 that may be open on one side to allow the orthodontist to engage the concave or convex portion 20, 21 with an appropriate tool, whereby the tool can be used to slide the cover 16.

An alternative or additional means for locking the cover in the open or closed position until moved by the orthodontist is to provide a detent, e.g., a bump, on the anterior surface 10 of the base 4, the bump fitting in and engaging one of the convex portions 20, 21, thereby locking the cover 16 in the open or closed position. Alternatively, a concave portion can be provided in the anterior surface 10 of the base 4, with the concave portion 20, 21 in the cover 16 fitting in and engaging the concave portion can be provided in the anterior surface 10 of the base 4, thereby locking the cover 16 in the open or closed position.

The concave or convex portions may also be elongated, e.g., in the shape of seep bumps 21′ shown in dashed lines in FIG. 1. The concave or convex portions 20, 21 or 21′ may be formed by stamping the cover 16.

As another alternative or additional means for locking the cover 16 in the open or closed position until moved by the orthodontist is to have the thickness of the grooves 12 narrow at the lower end, i.e., the portion into which the edges 18, 19 of the cover 16 are pushed as the cover 16 is slid into the closed position, so as to increase the friction between the grooves 12 and the edges 18, 19.

The grooves 12 may be open at one end at the back of the base 4 so that the cover 16 can be slid on or off the base 4.

The grooves 12 may also have a chamfer at points 22 and/or 23 so that the edges 18, 19 of the cover 16 slides easily in the grooves as the cover 16 is assembled into the base 4 and moved from the open to the closed position.

The base 4 may be provided with a slot 24 extending substantially in the occlusal-gingival direction on its posterior surface as shown in the figure so that, after the base 4 is attached to a bonding pad bonded to the tooth, the slot 24 can be used for a ligature wire. If the base 4 were to be bonded directly to the tooth, the slot would not be open to the posterior surface but would be a channel extending substantially in the occlusal-gingival direction spaced from the posterior surface. It is sometimes advantageous to have a bracket (tooth) fastened to an arch in a manner that produces a high friction unit. Conventional self-locking brackets have little friction produced when the arch is locked in the bracket arch slot. The wire is loose. The bracket of the present invention enables not only locking with the sliding cover 16 but also allows for tight ligature tying as well in order to produce a tooth that is tight on the arch if this is indicated and desired in any set of tooth moving procedures.

FIG. 2 is a side view of one part 4a of the two parts that in this embodiment make up the base 4. In this embodiment, the base 4 is made of two parts 4a, 4b having substantially mirror image shapes for ease of manufacture. In particular, it is easier to cast or mold the complex shape of the base 4 if it is formed in two parts. The two parts 4a, 4b, can have complimentary posts 25 and holes 26 so that they van be easily fitted together. For example the part 4a shown in FIG. 2 has two posts 25 that mate with correspondingly positioned holes (not shown) in part 4b, and a hole 26 into which a correspondingly positioned post (not shown) in part 4b fits. The two parts 4a, 4b can be attached, e.g., by welding or brazing, during manufacture or attached by the orthodontist.

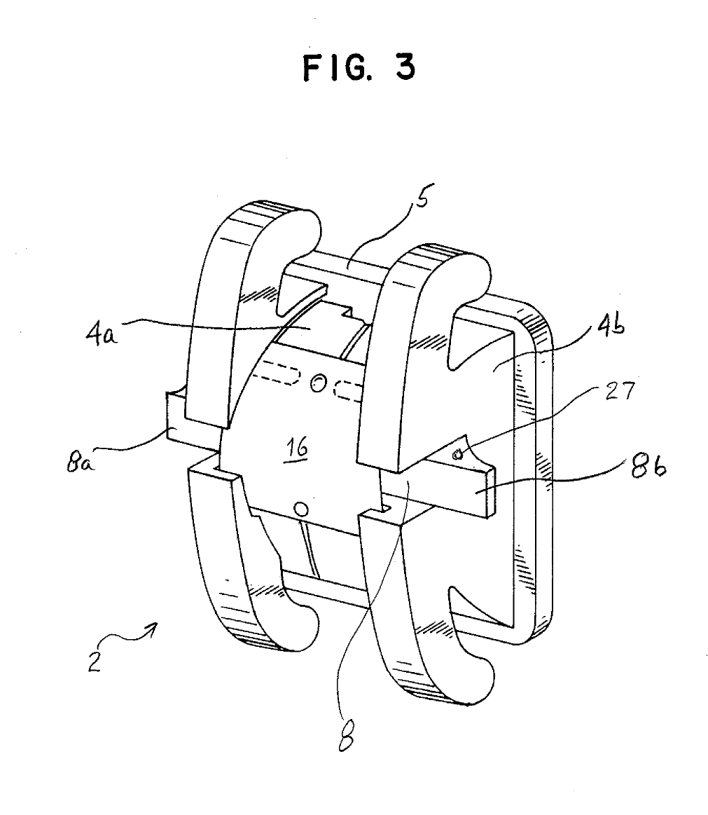

FIG. 3 is a perspective view of a second embodiment of the self-locking orthodontic bracket of the present invention. In this embodiment, the lingual surface of the archwire slot 8 has extensions 8a, 8b extending substantially in the mesiodistal direction from opposite sides of the base. The extensions 8a, 8b increase the width of the slot so as to aid in increasing the rotational effect. For example, if the width of the base (in the mesiodistal direction) is in the range of 0.07-0.15 in., the extensions 8a, 8b can each have a length, i.e., the length it extends beyond the bracket base, of, e.g., 0.05-0.08 in., e.g., 1/16 in. Of course, other sizes can be used as would be apparent to those skilled in the art based on this disclosure. In any case, this embodiment allows for increasing the rotational effect without increasing the width of the bracket base or allows to decrease the width of the bracket base without reducing the rotational effect. Each slot extension 8a, 8b may in a still further embodiment have a hole 27 extending therethrough in an occlusal-gingival direction for providing a ligature wire therethrough. The extensions 8a, 8b can be used with other types of brackets, e.g., the bracket shown and described in the provisional application Ser. No. 60/968,959.

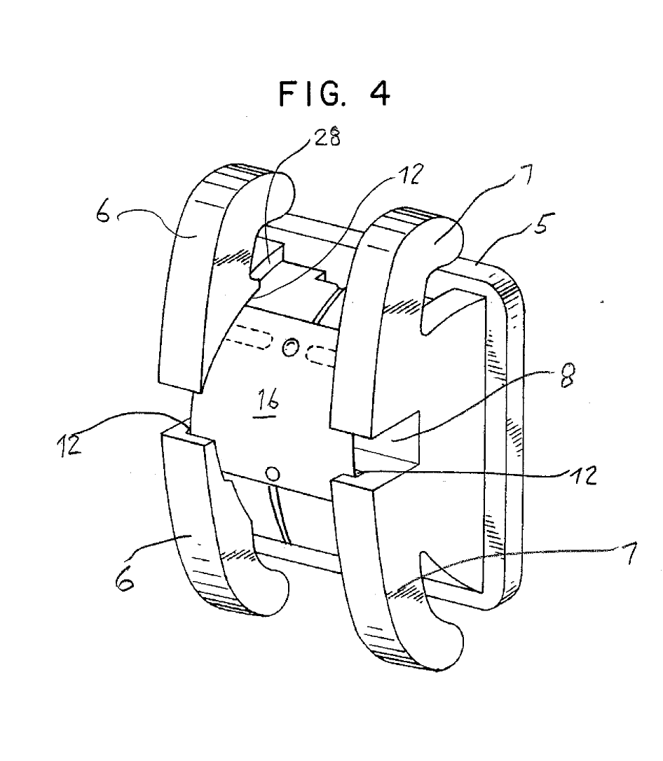

FIG. 4 is a perspective view of a third embodiment of the self-locking orthodontic bracket of the present invention. The embodiment of FIG. 4 differs from that of the first embodiment of FIG. 1 in that the entrance for insertion of cover 16 into the grooves 12 can include an open insertion area 28 in the upper part of the tie wings 6, 7 so that the cover can be easily inserted after the base 4 is attached to the pad 5. This can be advantageous especially in the case of the cover 16 being made of a superelastic alloy, e.g., superelastic NiTi, since the cover 16 can be inserted after, e.g., brazing of the base 4 to the pad 5 so as not to expose the cover 16 to high temperatures that may adversely affect the resiliency of the cover. It may be desirable in this embodiment to increase the radius of curvature of the grooves 12 so make rotation of the cover 16 easier and smoother.

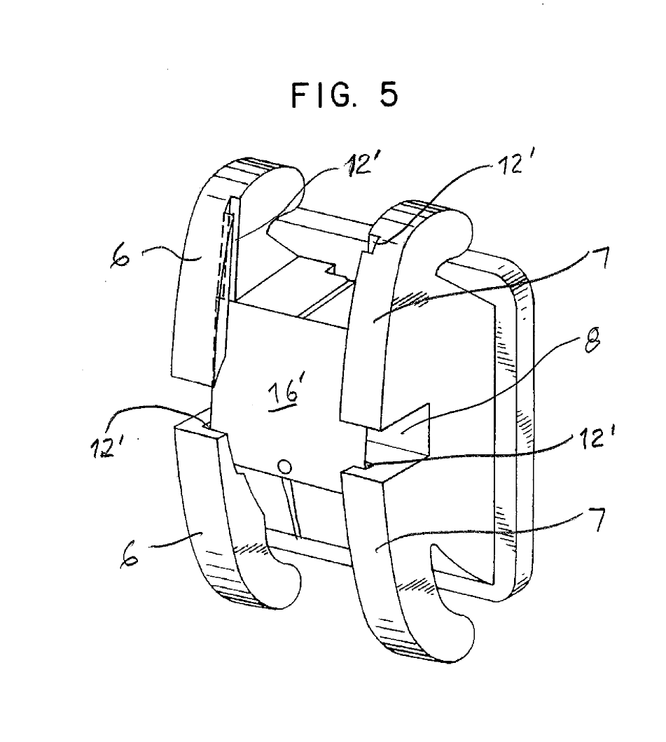

FIG. 5 is a perspective view of a fourth embodiment of the self-locking orthodontic bracket of the present invention. This embodiment differs from the first embodiment shown in FIG. 1 in that, in the fourth embodiment, the upper left and right tie wings 6, 7 are altered so that the seating grooves 12′ are placed in the facing tie wing surfaces in a vertical or almost vertical fashion, enabling the cover 16′ to travel in a straight line in the grooves 12′, vertical or slightly canted (tipped). The cover 16′ may have a slight curvature or be flat.

While the accompanying figure shows and this description describe some embodiments of the invention, the invention is not limited thereto. One skilled in the art will understand that numerous variations and modifications are possible without departing from the spirit and scope of the invention defined by the following claim(s).

I claim:

1. An orthodontic bracket comprising:
a base having a posterior surface adapted to be attached to a tooth;
an archwire slot extending through the base and the tie wings substantially in a mesiodistal direction; and
an archwire slot extensions extending substantially in the mesiodistal direction from opposite sides of the base.

2. The orthodontic bracket according to claim 1, further comprising a pair of substantially parallel, spaced tie wings extending from the base substantially in an occlusal-gingival direction.
